(19) United States
(12) Patent Application Publication
(10) Pub. No.: US 2024/0055714 A1
(43) Pub. Date: Feb. 15, 2024

(54) COMPACT BATTERY FOR POWER TOOL AND POWER TOOL WITH COMPACT BATTERY

(71) Applicant: Zhuhai Sharp-Group Enterprise Company, Ltd., Guangzhou (CN)

(72) Inventors: Michael E. Nipke, Wyoming, MI (US); Xiao Fei Yang, Guangzhou (CN)

(21) Appl. No.: 18/447,424

(22) Filed: Aug. 10, 2023

Related U.S. Application Data
(60) Provisional application No. 63/396,652, filed on Aug. 10, 2022.

(51) Int. Cl. H01M 50/244; H01M 50/213

(52) U.S. Cl. CPC H01M 50/244; H01M 50/213; H01M 2220/30

(57) ABSTRACT

A compact battery for energizing powered devices, such as a power drill, includes a housing that contains a nested row having a plurality of battery cells. Each battery cell has an outer circumference that is offset and overlapping in both a vertical direction and a horizontal direction with the outer circumference of an adjacent battery cell to form the compact battery. Optionally, the compact battery contains 6 battery cells that are electrically connected in series with one another; or 12 battery cells having a first nested row of 6 battery cells that are electrically connected in series with one another, and a second nested row of 6 battery cells that are electrically connected in series with one another. The first and second nested rows of battery cells are electrically connected in parallel with one another, and are nested with one another.

### CROSS REFERENCE TO RELATED APPLICATION

The present application claims priority of U.S. provisional application Ser. No. 63/396,652, filed Aug. 10, 2022, which is hereby incorporated herein by reference in its entirety.

### BACKGROUND AND FIELD OF THE INVENTION

The present invention is directed to a battery for powering an article of equipment, and particularly to a compact battery used for powering a power tool.

A person may use power tools for various purposes, such as for completing a task as part of a home improvement project. For example, a power drill could be used to drive screws through a drywall panel and into a wooden stud to secure the drywall panel to the stud when constructing a wall. A power tool may be energized or powered via a cord that electrically connects the power tool to an electrical outlet, or by a battery such as a rechargeable battery that can be selectively connected and disconnected from the power tool. As power tools become more compact, batteries used to energize power tools may become cumbersome due to the size of the batteries, and/or may not deliver a desired amount of power to a power tool given the size of the battery.

### SUMMARY OF THE INVENTION

The present invention provides a battery that may be used to power an article of equipment, such as a power tool. The battery has an outer housing that houses a chassis for supporting a plurality of battery cells, in which the chassis may be at least partially conductive to electrically connect the battery cells to one another. The battery cells are arranged in a nested pattern in which the outer circumference or radius of each battery cell overlaps in both a vertical direction and a horizontal direction with the outer circumference or outer circumference of an adjacent battery cell. The resulting arrangement of battery cells is spatially compact, and allows the battery to maintain a length or horizontal dimension that is identical or similar to that of a conventional battery having fewer battery cells. The battery is therefore adapted to deliver a desirable amount of power to the power tool while being dimensioned to limit its interference with the operation of the power tool.

According to one form of the invention, a compact battery for energizing a powered device includes a housing and a nested row having a number of battery cells. The battery cells are contained within the housing, where each battery cell has an outer circumference that is offset and overlapping in both a vertical direction and a horizontal direction with at least one of the outer circumferences of an adjacent battery cell.

In one aspect, the nested row is a first nested row, and the compact battery further includes a second nested row having a number of battery cells that are also contained within the housing. Each of the battery cells of the second nested row have an outer circumference that is offset and overlapping in both the vertical direction and the horizontal direction with at least one of the outer circumferences of an adjacent battery cell of the second nested row. Optionally, at least one of the outer circumferences of the battery cells of the first nested row is offset and overlapping in both the vertical direction and the horizontal direction with at least one of the outer circumferences of the battery cells of the second nested row. The battery cells of the first nested row may be connected in electrical series with one another, in which the battery cells of the second nested row are also connected in electrical series with one another. Additionally, the battery cells of the first nested row may be electrically connected in parallel with the battery cells of the second nested row.

In another aspect, the nested row has a horizontal length that is substantially equivalent to a horizontal length of a lineally-arranged row of battery cells having one less battery cell than the nested row. The battery cells of the lineally-arranged row have outer circumferences that are substantially equal to the outer circumferences of the battery cells of the nested row. Optionally, the nested row has 6 battery cells. The compact battery may also have a nominal voltage rating within a range of 21.2 volts to 22.0 volts.

In yet another aspect, the nested row has a horizontal length that is less than a horizontal length of a lineally-arranged row of battery cells, where the lineally-arranged row has the same number of battery cells as the nested row. The battery cells of the lineally-arranged row have outer circumferences that are substantially equal to the outer circumferences of the battery cells of the nested row. Optionally, the nested row may have 6 battery cells, or alternatively may have 5 battery cells.

In still another aspect, a chassis that electrically connects the battery cells to one another is contained within the housing and supports the battery cells.

In a further aspect, the compact battery is configured to be electrically connected to a handheld power tool.

According to another form of the present invention, a compact battery for powering a handheld power tool includes a nested row within a housing. The nested row includes a number of battery cells that are offset and overlapping in both a vertical direction and a horizontal direction with an adjacent battery cell.

In one aspect, the compact battery has a nominal voltage rating that is substantially equivalent to a battery having a lineally-arranged row of battery cells that are substantially identical to the battery cells of the nested row. The nested row has a horizontal dimension that is smaller than a horizontal dimension of the lineally-arranged row of battery cells. Optionally, the nested row has 6 battery cells. Each one of the battery cells may also have a nominal voltage rating within a range of 3.4 volts to 3.8 volts.

In another aspect, the battery cells are connected in electrical series with one another.

According to yet another form of the present invention, a compact battery for powering a handheld power tool has a nested row including 5 battery cells, where at least 2 of the battery cells are aligned with one another in a vertical direction, and offset and overlapping in the vertical direction with at least 3 of the other battery cells. Each of the battery cells is offset and overlapping in a horizontal direction with an adjacent battery cell. Optionally, the nested row has 6 battery cells, where 3 of the battery cells are aligned with one another in the vertical direction, and offset and overlapping in the vertical direction with the remaining 3 battery cells.

These and other objects, advantages, purposes and features of this invention will become apparent upon review of the following specification in conjunction with the drawings.

### BRIEF DESCRIPTION OF THE DRAWINGS

FIG. 1 shows a side elevation view of a power drill connected to a compact battery in accordance with the present invention in which an outer side of the battery has been removed to reveal six battery cells;

FIG. 2 shows conventional battery cell layouts for a five-celled battery and a six-celled battery, and shows a nested cell battery layout for a six-celled compact battery in accordance with the present invention;

FIGS. 3A-3D show various views of the compact battery of FIG. 1 in accordance with the present invention, where the compact battery includes six 18650 battery cells;

FIG. 3E shows a cross-sectional side elevation view of the compact battery of FIGS. 3A-3D;

FIGS. 4A-4D show various views of another compact battery in accordance with the present invention, where the compact battery includes six 21700 battery cells;

FIG. 4E shows a cross-sectional side elevation view of the compact battery of FIGS. 4A-4D;

FIGS. 5A-5D show various views of another compact battery in accordance with the present invention, where the compact battery includes five 21700 battery cells;

FIG. 5E shows a cross-sectional side elevation view of the compact battery of FIGS. 5A-5D;

FIG. 6A shows five 18650 battery cells in a conventional layout;

FIG. 6B shows six 18650 battery cells in a nested layout in accordance with the present invention;

FIG. 6C shows five 21700 battery cells in a nested layout in accordance with the present invention;

FIG. 6D shows five 21700 battery cells in a conventional layout;

FIG. 6E shows six 21700 battery cells in a nested layout in accordance with the present invention;

FIG. 7 shows a power drill connected to another compact battery in accordance with the present invention in which an outer side of the compact battery has been removed to reveal 12 battery cells in a nested layout;

FIGS. 8A-8D show various views of a conventional five 18650 cell battery in accordance with the present invention;

FIGS. 9A-9D show various views of a conventional five 21700 cell battery in accordance with the present invention;

FIG. 10 shows a side elevation view of a power drill connected to the conventional battery of FIGS. 8A-8D, in which an outer side of the battery has been removed to reveal five battery cells; and

FIG. 11 shows a side elevation view of a power drill connected to another conventional battery in which an outer side of the battery has been removed to reveal ten battery cells.

### DESCRIPTION OF THE PREFERRED EMBODIMENTS

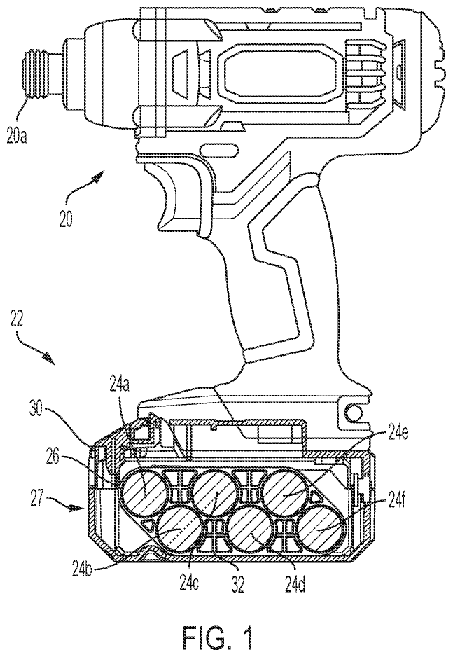

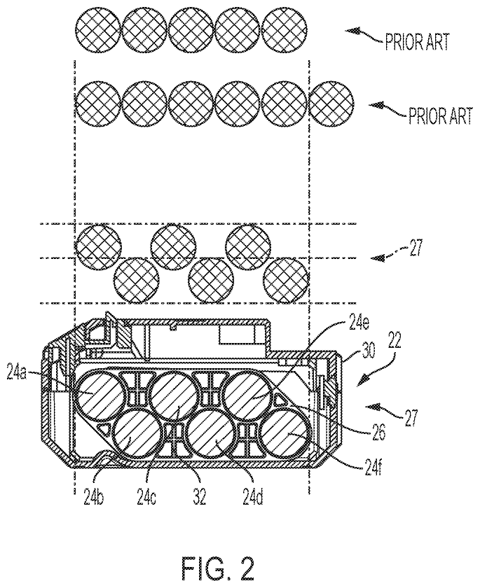

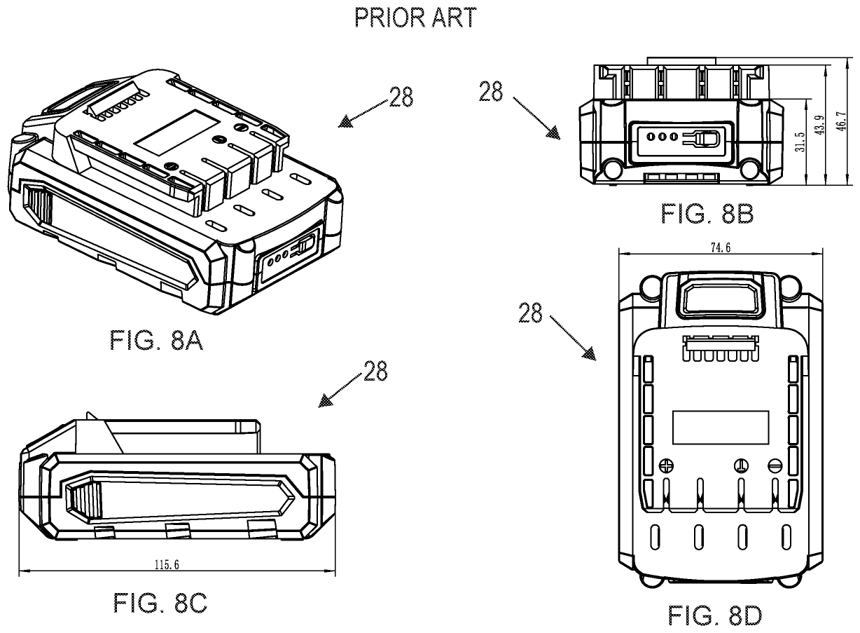

The present invention will now be described with reference to the accompanying figures, wherein the numbered elements in the following written description correspond to like-numbered elements in the figures. Referring to FIGS. 1-3E, a battery used to energize and/or power equipment, devices, and handheld power tools such as power drill 20, is depicted as a six-celled battery pack or compact battery 22. In particular, compact battery 22 includes six 18650 cylindrical lithium ion battery cells 24a-f that are electrically connected in series via a battery frame or chassis 26 that also supports and protects cells 24a-f. Cells 24a-f are oriented and positioned relative to one another such that each cell 24a-f is at least partially nested and/or overlapping in a vertical plane or direction and/or a horizontal plane or direction with an adjacent cell 24a-f. The resulting arrangement of cells 24a-f enables compact battery 22 to have a shortened or compact horizontal length, such as a horizontal length that is substantially equivalent to, or no greater than, a conventional battery such as conventional battery 28 having five linearly-arranged 18650 battery cells (FIGS. 2 and 8A-8D), while also delivering more power than conventional battery 28.

Compact battery 22 includes an outer casing, frame, shell, or housing 30 that encloses cells 24a-f and chassis 26. Chassis 26 is made at least in part of an electrically conductive material that allows it to electrically connect cells 24a-f to one another. In the illustrated embodiment, chassis 26 connects a nested row 27 of cells 24a-f in electrical series with one another. Chassis 26 has an inner lattice support structure 32 that strengthens chassis 26 to further support and protect cells 24a-f. It should be appreciated that a chassis may vary within the scope of the present invention. For example, a chassis could be configured to support more or less battery cells, and may have geometry that otherwise differs from chassis 26. Additionally, a chassis may support battery cells without being electrically conductive, in which the chassis may also provide support for electrically conductive materials that connect the battery cells to one another, such as wires, cables, plates, tabs, and/or other electrically connective features.

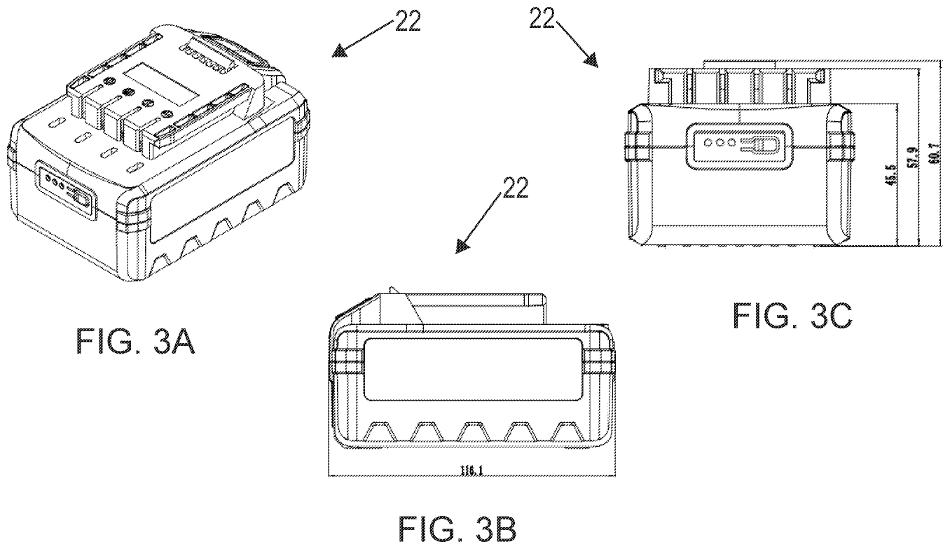

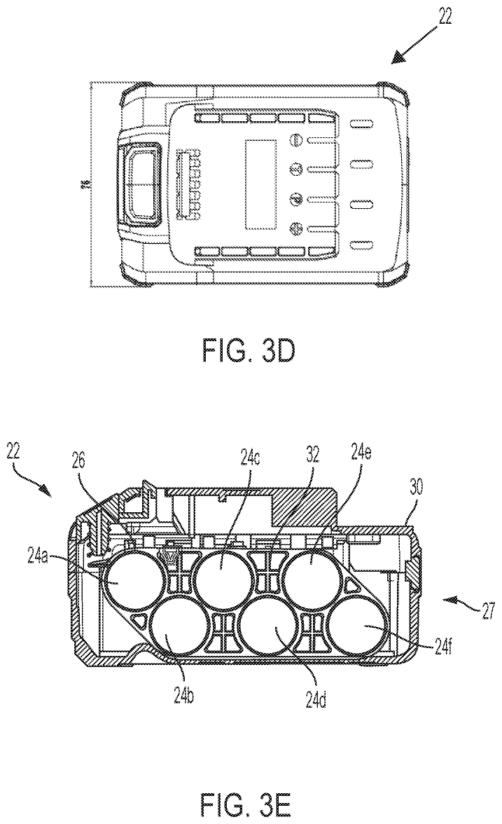

Wither particular reference to FIG. 2, cells 24a-f are nested relative to one another to allow compact battery 22 to contain or include more battery cells in a given volume, or in a given length dimension of compact battery 22. Specifically, cells 24a-f are arranged relative to one another such that an outer circumference or a radius of each cell 24a-f overlaps in both the vertical direction and the horizontal direction with the outer circumference or the radius of an adjacent cell 24a-f. By nesting cells 24a-f in this fashion, as opposed to a more lineal arrangement or configuration, compact battery 22 is able to contain at least an additional battery cell in substantially the same horizontal length as a conventional battery. Compact battery 22 has a slightly larger vertical dimension or height as compared to a conventional battery having only one lineal row of 18650 battery cells. Specifically, compact battery 22 is approximately 15 millimeters taller than conventional battery 28 (FIGS. 3A-3E and 8A-8D). It should be understood that reference herein to “horizontal” and “vertical” is relative to the orientation of the battery pack 22 and/or cells 24a-f when in the position as shown in FIGS. 1, 2, and 6A-6E. For example, the length may be considered the dimension along a line perpendicular to the axial length of the cells 24 and planar to planes defined by the upper and lower rows of cells 24, where the upper row is formed by 24a, 24c and 24e, and the lower row is formed by 24b, 24d and 24f. Correspondingly, the height may be considered the dimension along a line perpendicular to the axial length of the cells 24 and perpendicular to planes defined by the upper and lower rows of cells 24. The width-to-height ratio of compact battery 22 may be aesthetically appealing, and in particular, may give the visible impression of a more powerful battery or power tool while compact battery 22 is connected to a power tool.

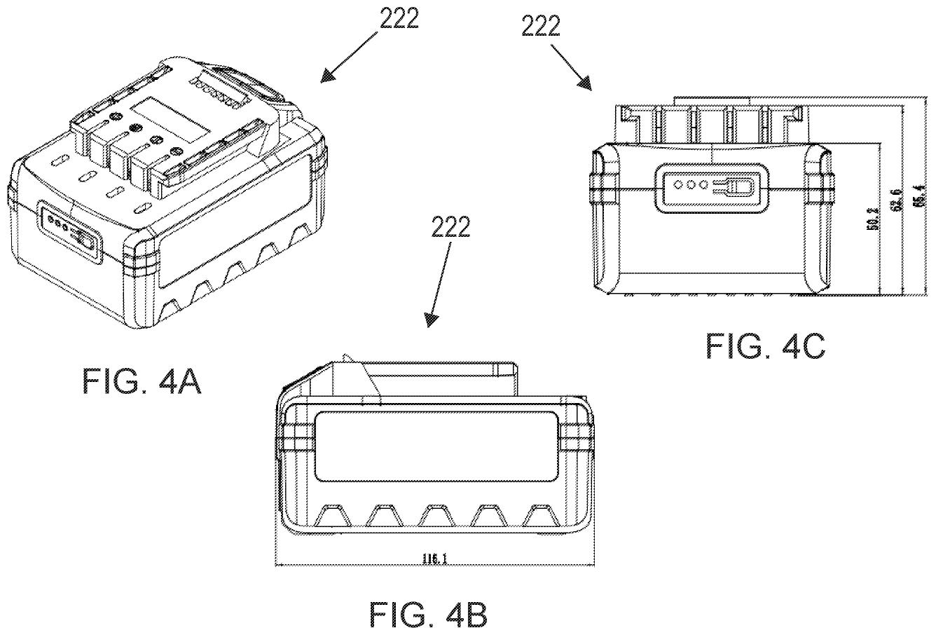

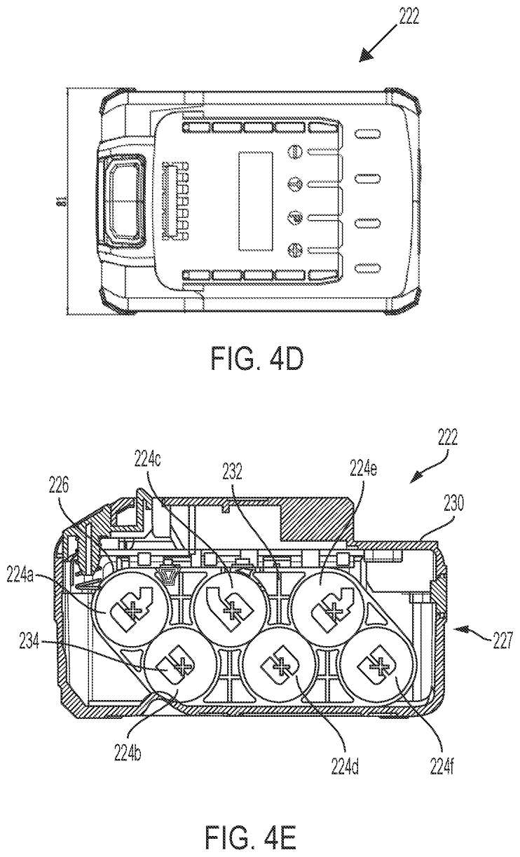

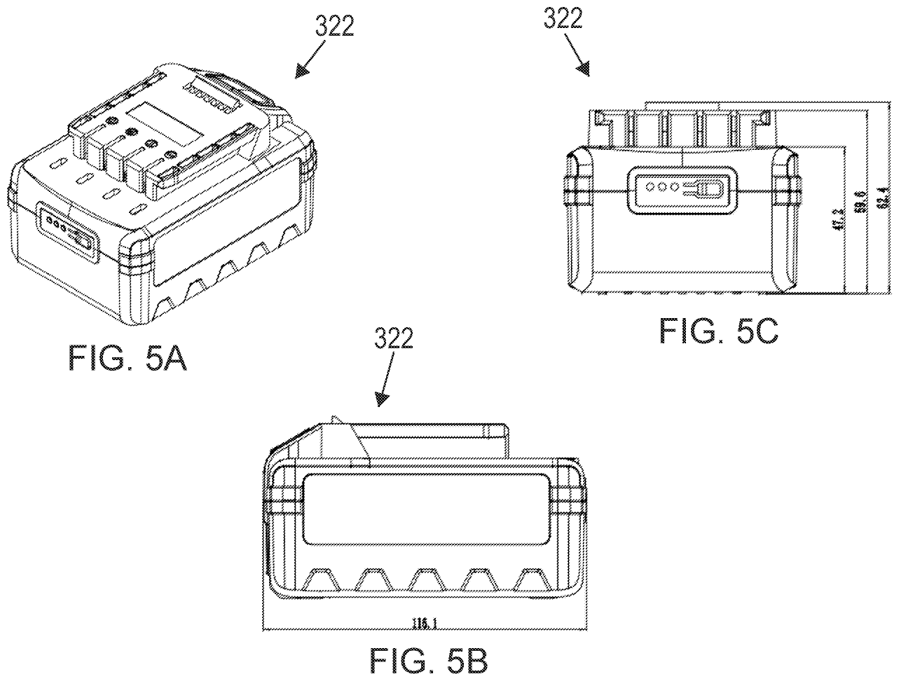

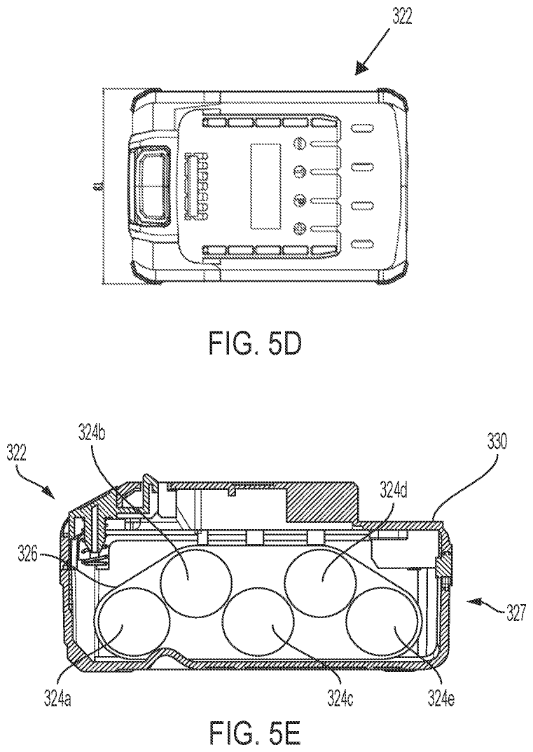

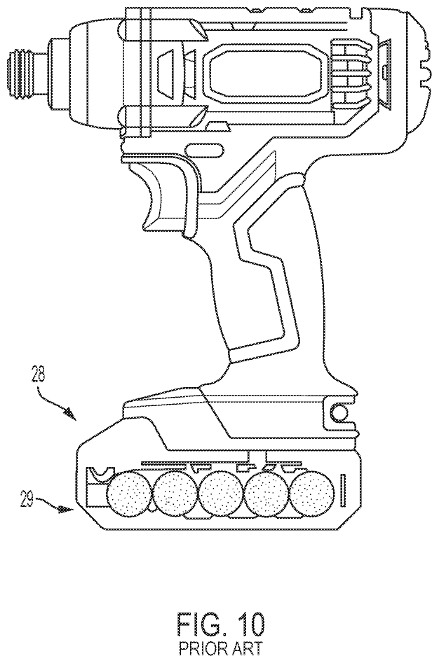

As previously noted, battery cells 24a-f are 18650 battery cells that reach or even exceed approximately 4 volts when fully charged. It should be appreciated that battery cells used or included in a compact battery may take alternative forms, for example, the 21700 cylindrical lithium ion battery cells that are included in compact battery 222 (FIGS. 4A-4E) and compact battery 322 (FIGS. 5A-5E) discussed infra herein. The voltage of cells 24a-f drops or is reduced as the charge level of cells 24a-f is reduced and/or depleted. The voltage of cells 24a-f may also depend on various other factors, including the ambient temperature as well as charging and discharging rates that cells 24a-f may be subjected to. Due to the varying voltage characteristics described above, cells 24a-f have been assigned a nominal voltage rating of approximately 3.6 volts. That is, each cell 24a-f is a 3.6 volt nominal rated battery cell. Cells 24a-f of compact battery 22 are wired and/or arranged in electrical series with one another, thus resulting in compact battery 22 having a nominal output voltage of approximately 21.6 volts. In comparison, and with reference to FIG. 10, conventional battery 28—which includes five 18650 battery cells wired in series—has a nominal output voltage of approximately 18 volts. Therefore, nested row 27 of compact battery 22 is able to provide more power than a lineal row 29, or row of lineally-arranged or aligned battery cells having outer circumferences and/or radii that are not offset and overlapping in both the vertical direction and the horizontal direction, of conventional battery 28 for a given horizontal dimension. Accordingly, compact battery 22 is able to energize a power tool or powered equipment in such a way that the tool or equipment may be operated, for example, at higher speeds, higher torques, and/or for a longer runtime than conventional battery 28.

Compact battery 22 may be selectively connected and disconnected from power drill 20. For example, compact battery 22 may become electrically depleted and/or run out of power necessary to appropriately energize power drill 20. When this occurs, a user may detach compact battery 22 from power drill 20, and then attach and/or electrically connect compact battery 22 to a charging device, such as a battery charger. After compact battery 22 has been sufficiently charged, the user may decouple compact battery 22 from the charging device and reconnect compact battery 22 to power drill 20. Compact battery 22 may include engagement features, such as ridges, flanges, and/or slots that mate with or engage with engagement features on power drill 20 to secure compact battery 22 to power drill 20. Furthermore, compact battery 22 may include a control board or circuit board that may regulate and/or control various characteristics of cells 24a-f, including the charge and discharge rates of cells 24a-f.

Referring again to FIG. 1, due at least in part to the compact horizontal configuration of compact battery 22, compact battery 22 is set or disposed horizontally back or rearward from a drill head or chuck portion 20a of power drill 20 while compact battery 22 is engaged with or electrically connected to power drill 20. In particular, a front or forward end, side, and/or surface of compact battery 22 is recessed or located rearward relative to a front or forward end of power drill 20, such as chuck portion 20a, while compact battery 22 is electrically connected to power drill 20. Furthermore, as shown in the illustrated embodiment, a rear or rearward end, side, and/or surface of compact battery 22 is recessed or located forward relative to a rear or rearward end of power drill 20 while compact battery 22 is electrically connected to power drill 20. Accordingly, compact battery 22 is less likely to obstruct or interfere with power drill 20 while the user is operating power drill 20, or any other powered equipment or tools that compact battery 22 is connected to. For example, when drilling a screw into an object such as a wall stud, the user may bring chuck portion 20a of power drill 20 into physical contact or close proximity with the stud without compact battery 22 making contact with the stud or otherwise interfering with the use of power drill 20.

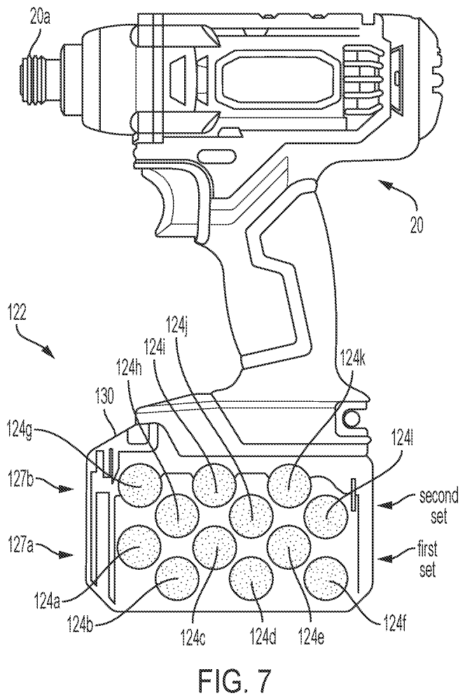

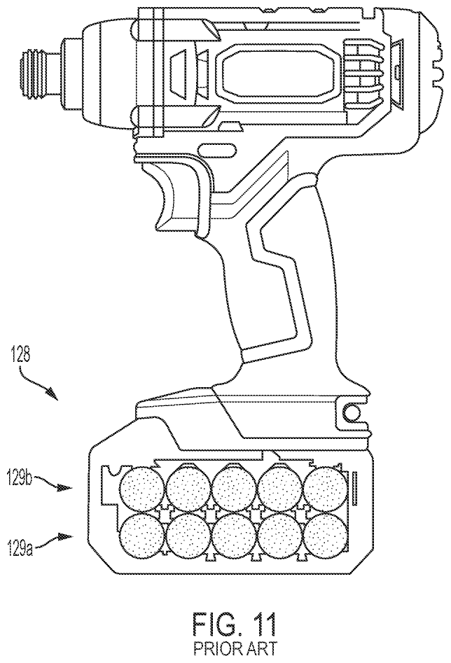

The total time that power drill 20 may be powered or energized to operate (the tool run time and/or battery run time) may be increased or otherwise altered by adding additional battery cells and/or nested rows of battery cells, or by using an alternative battery cell type, such as the previously mentioned 21700 battery cells. For example, an illustrated embodiment of another compact battery 122 having 12 battery cells 124a-1 in a first nested row 127a nested with a second nested row 127b is shown in FIG. 7. A first set of cells 124a-f are connected in electrical series with one another, a second set of cells 124g-1 are connected in electrical series with one another, and the first and second sets of cells 124a-f, 124g-1 are connected in electrical parallel with one another. Each cell 124a-1 is an 18650 lithium ion battery cell, but may take many other forms within the scope of the present invention, including a 21700 lithium ion battery cell. As described above, each 18650 cell is rated at approximately 3.6 volts nominal, thus resulting in first and second sets of cells 124a-f, 124g-1 being connected in electrical series and each having a nominal output voltage of approximately 21.6 volts. Accordingly, compact battery 122 also has a nominal output voltage of approximately 21.6 volts, but has double the battery capacity (amp hours) of six-celled compact battery 22. Additionally, compact battery 122 has substantially the same horizontal length as a conventional battery 128 (FIG. 11) having first and second lineal rows 129a, 129b, in which each row 129a, 129b has 5 battery cells, and in which conventional battery 128 has a nominal voltage output of approximately only 18V. Although not shown, compact battery 122 also includes a chassis and a lattice support structure to protect, support, and electrically connect battery cells 124a-1 to one another. Compact battery 122 also includes a housing 130, and may be selectively connected and disconnected from power drill 20 and various other power tools, powered equipment, and charging devices.

Referring now to the illustrated embodiment of FIGS. 4A-4E, another compact battery 222 is shown that is similar to compact battery 22, with similar features of compact battery 222 relative to compact battery 22 being designated with like reference numbers, but with “200” added to each reference number of compact battery 222. Due to the similarities of compact battery 222 relative to compact battery 22, not all of the components and features of compact battery 222 are discussed herein. Compact battery 222 includes six 21700 battery cells 224a-f that are electrically connected in series via a battery frame or chassis 226, and that are arranged in a nested row 227. Battery cells 224a-f are located internal to housing 230, and are further supported by lattice support structure 232. With particular reference to FIG. 4E, each battery cell 224a-f includes an electrical conductor, such as a metallic structure or feature that may electrically connect battery cells 224a-f to an electrical circuit or electrically conductive structure such as chassis 226.

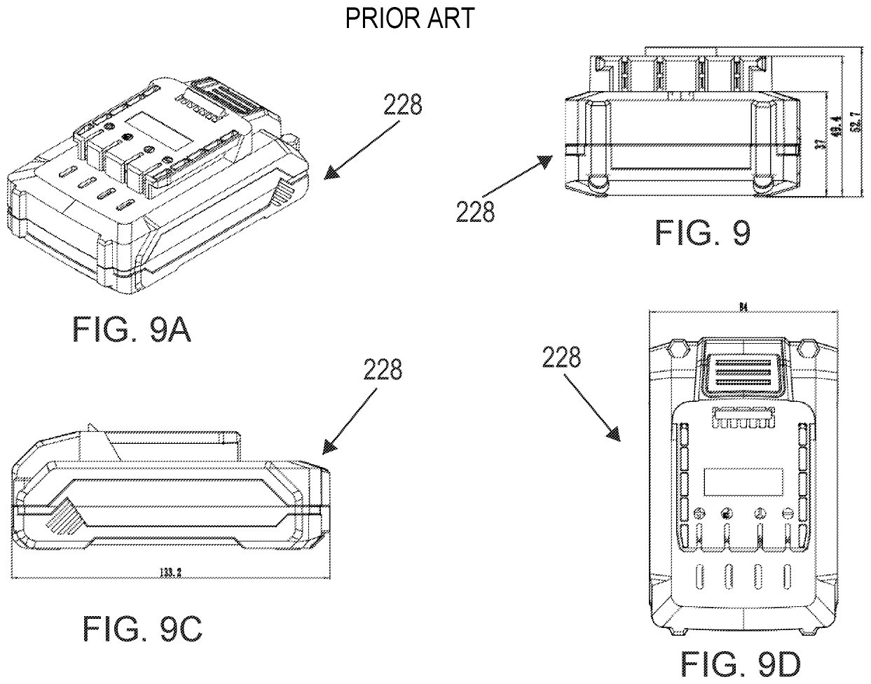

With further reference to the illustrated embodiment of FIGS. 5A-5E, another compact battery 322 is shown that is similar to compact battery 22, with similar features of compact battery 322 relative to compact battery 22 being designated with like reference numbers, but with “300” added to each reference number of compact battery 322. Due to the similarities of compact battery 322 relative to compact battery 22, not all of the components and features of compact battery 322 are discussed herein. Compact battery 322 includes five 21700 battery cells 224a-e that are electrically connected in series via a battery frame or chassis 326, and that are arranged in a nested row 327. Battery cells 324a-e are located internal to housing 330, and are further supported by a lattice support structure (not shown). With further reference to FIGS. 9A-9D showing a conventional battery 228 having five 21700 battery cells, the horizontal footprint and/or dimension of compact batteries 222 and 322 is less or smaller than conventional battery 228. This is the case, even though compact batteries 222 and 322 have equal or greater battery capacity as compared to conventional battery 228.

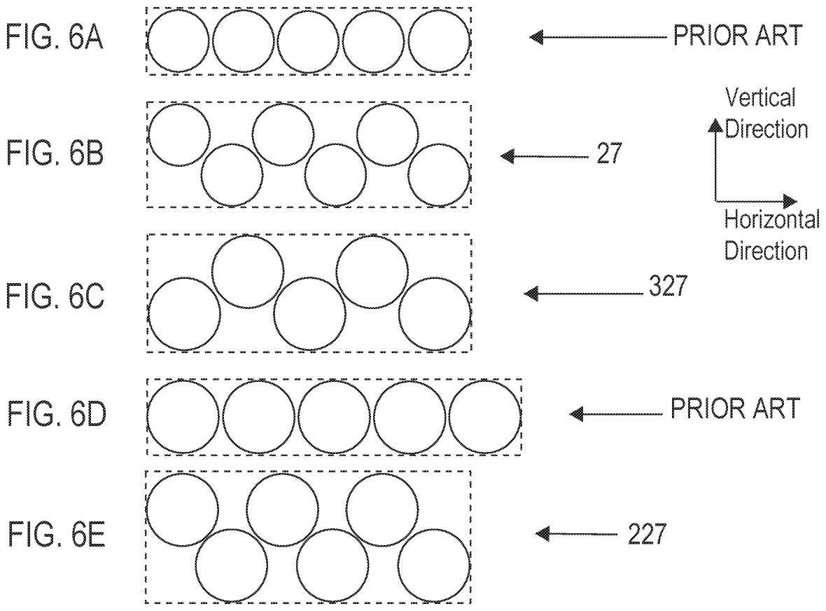

With reference to FIG. 6C showing nested row 327, and FIG. 6E showing nested row 227, both rows 327 and 227 are substantially equivalent in length in a horizontal dimension even though nested row 227 includes six 21700 battery cells while nested row 327 only includes five 21700 battery cells. This is due in part to the degree or extent of vertical and horizontal nesting or the arrangement of the battery cells relative to one another. In particular, the battery cells of nested row 227 are nested more horizontally relative to one another and less vertically relative to one another as compared to the battery cells of nested row 327. That is, adjacent battery cells of nested row 227 overlap to a greater extent in a horizontal dimension with one another, and to a lesser extent in a vertical dimension with one another, than do adjacent cells of nested row 327. As a result, although nested rows 227 and 327 have a substantially equivalent horizontal dimension, nested row 227 has a greater vertical dimension than nested row 327. It should be understood that the degree or extent of vertical nesting and/or horizontal nesting, such as has been described above with regard to nested rows 227 and 327, is also adjustable or variable for alternative nested rows in accordance with the present invention.

It should be appreciated that a compact battery may further incorporate additional battery cells and/or nested rows containing battery cells, which may be arranged and/or electrically connected in various ways that differ from the illustrated embodiments described above. For example, a compact battery could have 18 battery cells, in which sets of 6 cells are electrically connected in series, and in which the 3 sets of 6 cells are electrically connected in parallel with one another. Another compact battery may have 24 battery cells, in which sets of 6 cells are electrically connected in series, and in which the 4 sets of 6 cells are electrically connected in parallel with one another. Yet another compact battery may have 5 battery cells that are electrically connected in series. Still another compact battery may have 7 battery cells that are electrically connected in series. In each case, the horizontal dimension of a compact battery may remain the same as the illustrated embodiments described above, however, alternative embodiments may arrange battery cells in alternative ways that may increase or decrease the horizontal dimension and/or the vertical dimension of a compact battery having a certain number of battery cells.

It should also be appreciated that the voltage characteristics discussed herein, such as the nominal voltage rating of one or more battery cells, may vary within the scope of the present invention. For example, a battery cell having a 3.6 nominal voltage rating may vary within a range of 3.4 to 3.8 volts, for example, while a battery having a nominal voltage rating of 21.6 volts may vary within a range of 21.2-22.0 volts, for example.

Referring to FIGS. 6A-6E, and as discussed herein, the compact battery of the present invention enables a battery, battery pack, or the like, to provide or include more battery cells in a given volume, and in particular, in a given horizontal dimension. For example, a five 18650 battery cell in a conventional lineal arrangement (FIG. 6A) has substantially the same horizontal footprint or dimension as six 18650 battery cells arranged in nested row 27 (FIG. 6B), five 21700 battery cells arranged in nested row 327 (FIG. 6C), or six 21700 battery cells arranged in a nested row 227 (FIG. 6E). Additionally, nested rows 27, 227, and 327 have a smaller horizontal footprint and/or dimension as compared to five 21700 battery cells arranged in a conventional lineal arrangement (FIG. 6D). As shown, the battery cells of nested rows 27, 227, and 327 each include 2 or more battery cells that are aligned in a vertical direction with one another, but that are offset or unaligned and overlapping in a vertical direction with the other battery cells within the nested row. Additionally, all of the battery cells in nested rows 27, 227, and 327 are offset or unaligned and overlapping in a horizontal direction with at least one adjacent battery cell.

Accordingly, the compact battery of the present invention contains battery cells that are arranged in a spatially-efficient or compact manner by providing nested rows of the battery cells. The resulting arrangement of the battery cells allows the compact battery to contain more battery cells in a given horizontal dimension than a conventional battery, such as a battery that contains lineally-arranged battery cells. Thus, each nested row of battery cells of the compact battery is able to provide powered devices and equipment—such as devices and equipment that operate via electrical power supplied from a portable electrical source—with more power than a conventional battery of the same horizontal dimension for a given row of lineally-arranged battery cells, or a row of battery cells that are not nested in both horizontal and vertical directions. The compact horizontal dimension of the compact battery reduces the interference of the compact battery with the operation of the powered equipment such as a power tool.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A compact battery for energizing a powered device, said compact battery comprising:
a housing; and
a nested row comprising a plurality of battery cells contained within said housing, each of said battery cells having an outer circumference that is offset and overlapping in both a vertical direction and a horizontal direction with at least one of said outer circumferences of an adjacent one of said plurality of battery cells.

2. The compact battery of claim 1, wherein said nested row is a first nested row, and wherein said compact battery further comprises a second nested row comprising a plurality of battery cells contained within said housing, each of said battery cells of said second nested row having an outer circumference that is offset and overlapping in both the vertical direction and the horizontal direction with at least one of said outer circumferences of an adjacent one of said plurality of battery cells of said second nested row.

3. The compact battery of claim 2, wherein at least one of said outer circumferences of said plurality of battery cells of said first nested row is offset and overlapping in both the vertical direction and the horizontal direction with at least one of said outer circumferences of said plurality of battery cells of said second nested row.

4. The compact battery of claim 3, wherein said plurality of battery cells of said first nested row are connected in electrical series with one another, and wherein said plurality of battery cells of said second nested row are connected in electrical series with one another.

5. The compact battery of claim 4, wherein said plurality of battery cells of said first nested row are electrically connected in parallel with said plurality of battery cells of said second nested row.

6. The compact battery of claim 1, wherein said nested row has a horizontal length that is substantially equivalent to a horizontal length of a lineally-arranged row of battery cells having one less battery cell than said nested row, and wherein the battery cells of the lineally-arranged row have outer circumferences that are substantially equal to said outer circumferences of said plurality of battery cells of said nested row.

7. The compact battery of claim 6, wherein said nested row consists of 6 battery cells.

8. The compact battery of claim 7, wherein said compact battery has a nominal voltage rating that is within a range of 21.2 volts to 22.0 volts.

9. The compact battery of claim 1, wherein said nested row has a horizontal length that is less than a horizontal length of a lineally-arranged row of battery cells having the same number of battery cells as said nested row, and wherein the battery cells of the lineally-arranged row have outer circumferences that are substantially equal to said outer circumferences of said plurality of battery cells of said nested row.

10. The compact battery of claim 9, wherein said nested row consists of 6 battery cells.

11. The compact battery of claim 9, wherein said nested row consists of 5 battery cells.

12. The compact battery of claim 1, wherein said compact battery further comprises a chassis contained within said housing and configured to support said plurality of battery cells, and wherein said chassis electrically connects said plurality of battery cells to one another.

13. The compact battery of claim 1, wherein said compact battery is configured to be electrically connected to a handheld power tool.

14. A compact battery for powering a handheld power tool, said compact battery comprising:
a housing; and
a nested row within said housing and comprising a plurality of battery cells that are offset and overlapping in both a vertical direction and a horizontal direction with an adjacent one of said plurality of battery cells.

15. The compact battery of claim 14, wherein said compact battery has a nominal voltage rating that is substantially equivalent to a battery having a lineally-arranged row of battery cells that are substantially identical to said plurality of battery cells of said nested row, wherein said nested row has a horizontal dimension that is smaller than a horizontal dimension of the lineally-arranged row of battery cells.

16. The compact battery of claim 15, wherein said nested row consists of 6 battery cells.

17. The compact battery of claim 16, wherein each one of said plurality of battery cells has a nominal voltage rating within a range of 3.4 volts to 3.8 volts.

18. The compact battery of claim 17, wherein said plurality of battery cells are connected in electrical series with one another.

19. A compact battery for powering a handheld power tool, said compact battery comprising:
a nested row comprising 5 battery cells, at least 2 of said battery cells aligned with one another in a vertical direction, and offset and overlapping in the vertical direction with at least 3 of said battery cells, wherein each one of said battery cells is offset and overlapping in a horizontal direction with an adjacent one of said battery cells.

20. The compact battery of claim 19, wherein said nested row consists of 6 battery cells, 3 of said battery cells aligned with one another in the vertical direction, and offset and overlapping in the vertical direction with the remaining 3 of said battery cells.
